(19) United States
(12) Patent Application Publication
(10) Pub. No.: US 2007/0160893 A1
(43) Pub. Date: Jul. 12, 2007

(54) Polymer electrolyte fuel cell and separator used in a polymer electrolyte fuel cell

(76) Inventors: Katsunori Nishimura, Hitachiota (JP); Yuuki Okuda, Hitachi (JP); Jinichi Imahashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/527,408

(22) Filed: Sep. 27, 2006

(30) Foreign Application Priority Data
Jan. 11, 2006 (JP) 2006-003167

(51) Int. Cl. H01M 8/02; H01M 8/10

(52) U.S. Cl. 429/38; 429/30

(57) ABSTRACT

A polymer electrolyte fuel cell having a separator for separating a fuel gas from an oxidant gas and a solid polymer electrolyte membrane, wherein the separator has a gas passage formed by a channel for flowing a fuel gas or an oxidant gas through thereof, and the shape of the cross section of the channel is restricted by a channel width A and a channel depth B, where B is greater than or equal to A/2 but smaller than or equal to A.

### CLAIM OF PRIORITY

The present application claims priority from Japanese application serial No. 2006-003167, filed on Jan. 11, 2006, the content of which is hereby incorporated by references into this application.

### BACKGROUND OF THE INVENTION

1. Field of Technology

The present invention relates to a polymer electrolyte fuel cell that does not easily allow a voltage drop to be caused due to a gas passage blockade during power generation by the fuel cell, and also relates to a fuel cell power generation system in which the polymer electrolyte fuel cell is mounted.

2. Prior of Art

A polymer electrolyte fuel cell has advantages that, for example, starting and stopping can be performed with ease because of a high output, a long life, less deterioration due to starting and stopping, low operation temperatures (about 70° C. to 80° C.), and the like. Accordingly, polymer electrolyte fuel cells are expected to be usable in a wide range of applications such as power supplies for electric cars and business-use and home-use dispersed power supplies.

One of these applications is a dispersed power supply system, such as, for example, a cogeneration power generation system, in which a polymer electrolyte fuel cell is mounted. In this system, when electricity is drawn from the polymer electrolyte fuel cell, heat generated from the fuel cell during power generation is collected as hot water, enabling energy to be used efficiently. This type of dispersed power supply is required to have a service life of 50,000 hours or more. So, improvements are being performed in membrane-electrode assemblies, cell structures, power generation conditions, and the like.

To achieve such a long service life, the stability of voltage needs to be increased. The voltage of a fuel cell is a total of voltages of individual cells in the fuel cell. It is desirable that the voltage of each cell be stable. However, the voltage of each cell may be unstable, the main cause of which is water droplets accumulated in the gas passage in the cell. The accumulated water droplets block the passage or cause flooding from (wetting to) the electrode surface, hindering hydrogen oxidation reaction or oxygen reduction reaction at the electrode.

If reaction is hindered as described above, catalyst dissolution, conductive material oxidation, and other undesirable reactions proceed by an amount equivalent to the amount of extra gas which is left unconsumed after current flowing in each cell is generated during power generation. As a result, the catalyst deteriorates, the contact resistance of the separator is increased due to oxidation, and other problems occur. The service life of the cells is finally shortened.

To prevent this type of passage blockade and flooding, if water droplets are generated, they need to be discharged from the cells before they reach the electrode or discharged immediately from the gas passages in the separator. The separator is preferably provided with passages from which water can be discharged before the passages are blocked.

Many inventions related to passage structures have been applied as patent applications. In a typical invention as a prior art disclosed, the cross sectional area of a passage is extremely small (Patent Document 1). Specifically, the cross sectional area of a channel is 0.3 mm² or less. In other prior art in another respect, the amount of water supplied in fuel and the amount of water discharged are limited to prescribed ranges to prevent flooding even when the flow rate of fuel is low (Patent Document 2).

[Patent Document 1] Japanese Application Patent Laid-open Publication No. 2004-327091

[Patent Document 2] Japanese Application Patent Laid-open Publication No. 2005-158722

### SUMMARY OF THE INVENTION

An object of the present invention is to provide a fuel cell that enables stable electric power to be obtained during its activation.

In a polymer electrolyte fuel cell having a separator for separating a fuel gas from an oxidant gas and a solid polymer electrolyte membranes, wherein the separator has gas a passage formed by a channel for flowing a fuel gas or an oxidant gas through thereof, and the shape of the cross section of the channel is restricted by a channel width A and a channel depth B, where B is greater than or equal to A/2 but smaller than or equal to A.

A fuel cell according to the present invention enables stable electric power to be obtained during its activation.

### BRIEF DESCRIPTION OF THE DRAWINGS

FIG. 1 is a cross sectional view of a fuel cell according to an embodiment of the present invention.

FIG. 2 is an enlarged cross sectional view of a passage in a separator according to a passage model of the present invention.

FIG. 3 shows a relation between the channel depth and the stabilization index for passage shapes according to embodiments of the present invention.

FIG. 4 shows a definition of contact angle of a water droplet in a separator passage.

FIG. 5 is an overall view of the separator according to another embodiment of the present invention.

### DETAILED DESCRIPTION OF THE INVENTION

An embodiment of the present invention for making voltage stable will be described below. It will be appreciated that the present invention is not limited to the method described below.

This embodiment assumes that each gas passage in the separator is an angular channel, an angular channel having taper angles on the channel side, or a generally angular channel having a round bottom. The channel width of a channel having the round bottom is an average of a distance between points at which the roundness starts on the sides of the channel and a distance between points at which the roundness ends and the channel is flattened. When the width of the bottom of the channel and the depth of the channel are defined as A and B, respectively, if the following equation (1) is held, the ease with which water droplets are discharged can be improved.

A/2≦B≈A (1)

For the shape of the passage in this embodiment, the channel depth B is small with respect to the channel width A, so the passage is wide and flat. In the description that follows, therefore, the separator in this embodiment is referred to as a broad channel separator (BCS).

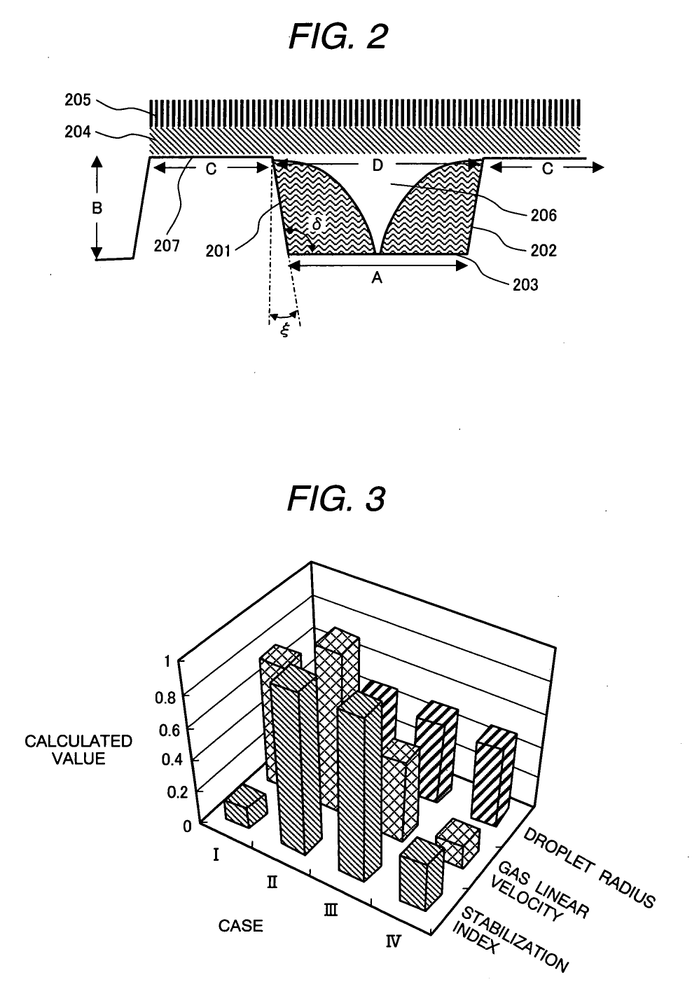

Features of the BCS will be described in detail with reference to a blocked passage model of the present invention shown in FIG. 2.

When a water droplet 201 is formed, it often adheres to a channel bottom 203 and a channel side 202. The inventors know from experience that the water droplet 201 often adheres to a corner of the channel, as shown in FIG. 2. FIG. 2 is a cross sectional view of a passage, indicating that two water droplets adhere to both corners of the channel in a critical state, in which if the water droplets 201 further become greater in size, they are brought into contact with a gas diffusion layer 204. If the water droplets 201 touch the gas diffusion layer 204, gas supply to the electrode layer 205 of the membrane-electrode assembly is hindered, causing a cell voltage drop with ease.

If the water droplets further develop from the state in FIG. 2, the entire passage is blocked, and gas insufficiency occurs downstream of the gas, starting from the positions at which the water droplets are present. This causes a substantial voltage drop. Before the passage is extremely blocked as described above, however, the cross sectional area of a space 206 through which the gas passes is reduced and the gas linear velocity is usually increased. As a result, the water droplets are discharged with ease. If the water droplets develop faster than the gas linear velocity being increased, the passage tends to be blocked.

According to this type of model, the amount of water droplet that can be preset until it touches the gas diffusion layer is represented by using a water droplet radius. The larger the water droplet radius is, the more water droplet the passage can accommodate, facilitating avoidance of a voltage drop due to a passage blockade. The gas linear velocity at that time was also calculated. The larger the gas linear velocity is, the easier the droplet is to discharge.

Therefore, an index representing difficulty in causing a blockade in a passage in the separator (the index is referred to below as the stabilization index) was represented as the product of a water droplet radius and a gas linear velocity, and the relation between the channel depth and the stabilization index was investigated.

Cases I to IV in FIG. 3 were investigated.

In case I, the passage has a shape for which B is smaller than A/2, indicating that the separator is out of the range in the present invention.

In case II, the passage has a shape for which B is equal to A/2, indicating that the separator is acceptable as one type of BCS in the present invention.

In case III, the passage has a shape for which B is equal to A, indicating that the separator is acceptable as one type of BCS in the present invention.

In case IV, the passage has a shape for which B is greater than A, indicating that the separator is out of the range in the present invention.

In each case, the maximum diameter of the water droplet 201 and the cross sectional area of the space 206 were estimated to obtain allowable water droplet radius and gas linear velocity. FIG. 3 shows the product of these water droplet radii and gas linear velocities as stabilization indexes, indicating that the passage is not blocked with ease in cases II and III and thereby highly stable voltage is obtained in these cases. It is understood that the range of channel dimensions for obtaining highly stable voltage is such that the channel depth B with respect to the channel width A is within the range from A/2 to A. This index was confirmed in examples described below.

To make the separator thin and miniaturize the cell, the channel depth B is further preferably greater than or equal to A/2 but small than A.

To reduce the contact resistance between the separator and the gas diffusion layer or membrane-electrode assembly and assure a gas diffusing velocity necessary for power generation, the rib width C in the gas passage must be set within the range from A/2 to 2A, both inclusive. The rib (indicated by the reference numeral 207 in FIG. 2) is a convex part formed between two passages, the rib being in touch with the gas diffusion layer or membrane-electrode assembly.

If the rib width C is too small, the contact area between the separator and the gas diffusion layer is lessened, increasing the contact resistance. The lower limit of the rib width C is preferably at least 50% of the channel width A, that is, A/2≦C.

Conversely, if the rib width C is too large, the gas diffusing velocity below the rib is lowered, causing a power generation failure. The upper limit of the rib width C is preferably twice the channel width A at most, that is, C≦2A. In particular, the porosity (ratio of the volume of fine pores to the apparent volume) of a carbonaceous gas diffusion layer is from 85% to 95% or the thickness is within the range from 100 to 300 μm, the above condition is effective in suppressing a voltage drop. The rib width C that satisfies the requirements described above is defined by equation (2).

A/2≦C≦2A (2)

When the above carbonaceous gas diffusion layer is used, if the rib width C is more than or equal to 0.5 mm but less than or equal to 2 mm, both improvement in gas diffusion and reduction in electric resistance can be achieved. In particular, when the current density during rated power generation is 0.1 to 0.4 A/cm², an effect in making voltage stable is obtained readily.

Strictly speaking with respect to equation (2) above, the resistance of electrons received and emitted on the membrane-electrode assembly between ribs is affected by the distance D between ribs shown in FIG. 2. In the above description, the angle δ shown in FIG. 2 is 90° or a near value (70° or more), equation (2) can be applied without a problem. If δ is significantly more than 90° (δ>90°), D must be smaller than or equal to 2A so as to reduce the electron resistance. This will be described below in detail.

The taper angle of the passage is defined as the angle ξ shown in FIG. 2. For the channel shape shown in FIG. 2, the following relation holds if the unit of angle is radian; δ=ξ+π/2

The channel width A must satisfy requirements described below. If the channel width A is too small, when the separator is molded with a die, the die cannot be drawn with ease. For a mold graphite separator, for example, the die bites into the graphite plate; when the die is drawn, channels may be destructed. Conversely, if the channel width A is too large, molding can be performed readily, but the distance over which electrons received and emitted on the membrane-electrode assembly on the channel are transmitted to the rib is increased. This increases the electron resistance and thereby causes a voltage drop. To prevent this, the channel width A should satisfy equation (2) above.

The best dimensions of a separator having a shape as described above are such that A is more than or equal to 0.5 mm but less than or equal to 2 mm. In view of the ease with which the die is drawn after the separator has been molded, too narrow channels lower the moldability, so A is preferably 0.5 mm or more. However, too large A lowers the efficiency of current collection on the top of the channel, so A should be 2 mm or less. According to equation (1), B is 0.25 mm or more and 2 mm or less. The channel depth affects the separator thickness, so B is more preferably set to 1 mm or less so as to make the cell compact. The rib width C is preferably 0.5 mm or more but 2 mm or less. If a separator used has dimensions within the ranges described above and satisfies equation (1), stable voltage can be obtained and the separator thickness can also be reduced. Accordingly, a compact polymer electrolyte fuel cell having superior voltage stability can be provided.

For a polymer electrolyte fuel cell operating under a rated power generation condition, in which the current density is 0.1 to 0.4 A/cm², the hydrogen utilization ratio is 70% or more and the oxidant utilization ratio is 40%. As a fuel, pure hydrogen or a hydrogen containing gas resulting from improvement of carbon-based fuel using a natural gas or kerosene is used. The oxidant may be oxygen, but air is typically used because of a low cost and easy maintenance. For this type of fuel cell, it is preferably that the separator for fuel has a channel width A and rib width C of 0.7 to 1.3 mm and a channel depth B of 0.4 to 0.6 mm, and the separator for an oxidant has a channel width A and rib width C of 0.7 to 1.3 mm and a channel depth B of 0.5 to 0.8 mm.

A high hydrogen utilization ratio causes the amount of gas at the exit to be significantly reduced after power generation and thus the linear velocity of the gas is lowered. As a result, water droplets accumulated in the passage are not discharged easily. For this reason, the channel depth on the fuel side is set to a value smaller than the channel depth on the oxidant side. If the channel depth B is small, the cross sectional area of the passage is made small, increasing the efficiency of discharging. In the separator for the oxidant, since the ratio of nitrogen in the oxidant (air) is large, the velocity of the gas at the exit of the passage is not reduced easily, as compared with the separator for the fuel. In addition, the amount of oxidant supplied is larger than the amount of fuel supplied, so in order to prevent a pressure rise in the separator passage, the cross sectional area of the passage needs to be expanded by making the passage for the oxidant deeper than the passage for the fuel.

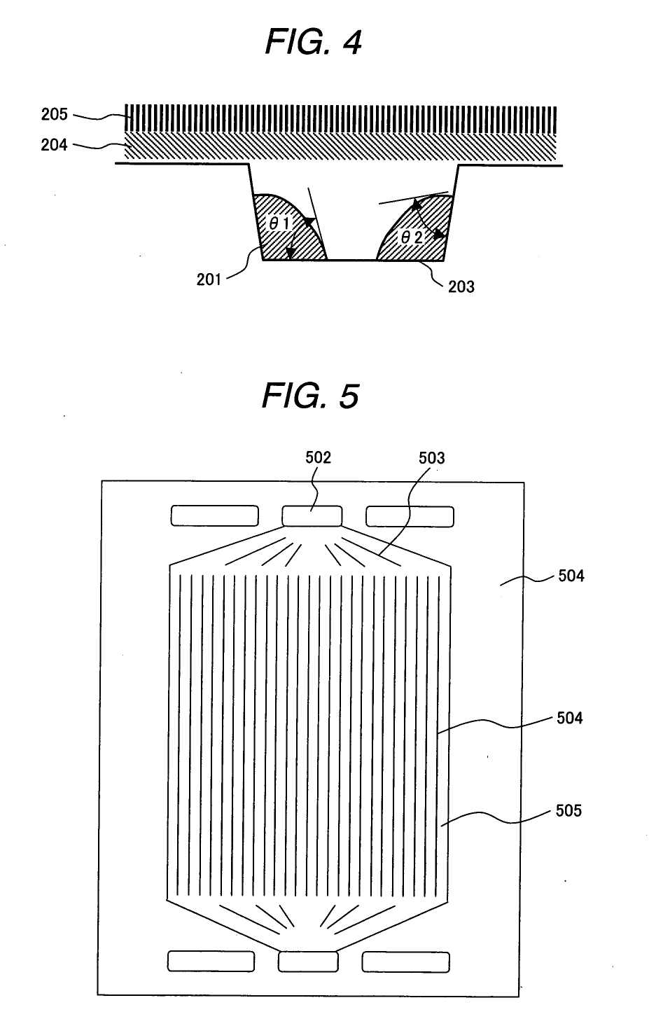

To further increase the effect, the contact angle of a water droplet in the separator passage is preferably 90° or less. The contact angle in the passage is defined to be θ1 shown in FIG. 4. In addition to θ1, contact angle θ2 with respect to a side of the passage can be defined as another contact angle of the water droplet. Assuming that gravity acts toward the lower side of the drawing, the contact angles may not match due to the weight of the water droplet. To eliminate the effect by gravity, θ1 is defined as the primary contact angle in this embodiment.

Even if the shape of the passage satisfies equation (1), the water droplet may be affected by gravity depending on the state of the separator or the orientation in which the separator is disposed, causing a difference between θ1 and θ2. In this case, the contact angle in the present invention is secondarily an average of θ1 and θ2.

The contact angle θ1 or θ2 can be measured by use of a contact angle measuring apparatus that has a high-speed camera and includes a function for acquiring as an image a droplet shape observed from the cross section of the passage. Accordingly, a contact angle of a water droplet, which is difficult to measure due to its evaporation, can be measured.

The contact angle can be set to 60° to 90° easily if it is subject to surface treatment such as blast treatment. If a graphite material is selected, the contact angle can be set even within a range of 20° to 90°. Even if the surface is coated with a hydrophilic treatment agent to set the contact angle to substantially 0°, the effect in this embodiment is not impaired.

When a separator that forms a contact angle of 20° to 90° is used, the length of the opening at the top of the gas passage (the width of the spacing between two ribs in FIG. 2) is defined as D. To allow the die to be drawn, δ needs to be greater than 90° (see FIG. 2). In the case of machining by cutting, δ can be set to 90°. In either case, δ is 90° or more. In this case, D is more than or equal to A.

If D is too large, the electron resistance between ribs is increased. To prevent this, D may be set so that the upper limit (2A) in equation (2) is not exceeded. If the upper limit is exceeded, the distance to the nearest rib over which electrons transmitted and emitted on the membrane-electrode assembly between ribs travel is increased, and the electron resistance is thus increased, as described above. If the passage is structured so that the rib width C is greater than or equal to A/2 but smaller than or equal to 2A and the rib interval D is smaller than or equal to 2A, an increase in the electron resistance between ribs can be suppressed.

As described above, a polymer electrolyte fuel cell having superior voltage stability can be provided by using a separator having a passage shape satisfying the condition that B is greater than or equal to A/2 but smaller than or equal to A. If the contact angle of a water droplet in the separator passage is set to 90° or less to obtain a suitable effect, a fuel cell using a separator having superior voltage stability can be provided.

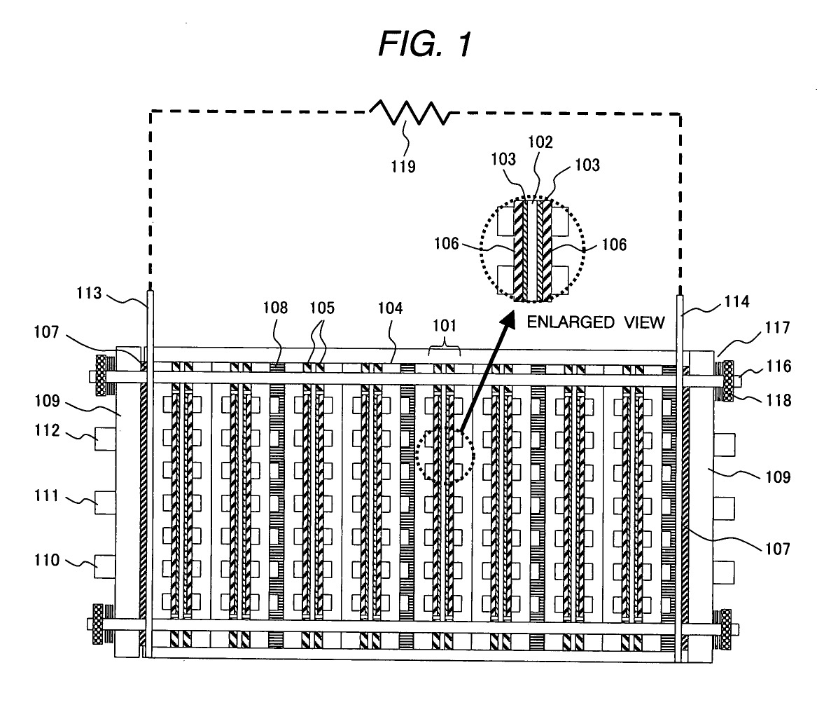

FIG. 1 is a cross sectional view of a fuel cell in which the separator in this embodiment is used is used. A single cell 101 comprises a membrane-electrode assembly (MEA), which is formed by joining electrode layers 103 on both sides of an electrolyte membrane 102, gas diffusion layers 106, and separators 104 for holding these elements, as shown in an enlarged view.

To prevent a gas leakage, a gasket 105 is placed on the joint surface of each separator 104. To eliminate heat during power generation, coolant separators 108 through which the coolant flows are disposed.

A single cell 101 and a coolant separator 108 are interconnected in series as by a stacked body. Electric power is output from a current collecting plate 113 and another current collecting plate 114 at both ends of the fuel cell, and supplied to an outside load.

A fuel gas is supplied from a fuel gas piping connector 110 to each single cell 101 through a manifold (manifold 502 in FIG. 5). A coolant and oxidant gas are also supplied from a piping connector 111 and oxidant gas piping connector 112, respectively, in the same way.

The stacked bodies are tightened by passing bolts 116 through end plates 109, placing conical springs 117 and nuts 118 on the bolt, and tightening the nuts. A plurality of fuel cells having this type of structure in which only the cross sections of separator passages differed were fabricated.

As shown in FIG. 2, the cross section of the passage comprises a flat channel bottom 203 and channel sides 202 slanted at an angle, each of which is part of a rib 207. The taper angle δ of the slanted side is 5°. When δ is within the range of 0° to 20°, it was confirmed in this embodiment that there was no significant difference in the effect according to the angle.

FIG. 5 is an external view of the separator 501 used in this embodiment. Manifolds 502 for a fuel gas are disposed at the center of the upper portion in the separator 501 and the center of the lower portion. Manifolds on the right and left are used for an oxidant gas or coolant. The fuel gas passes through the manifold 502, and then passes through a fuel distribution control section 503 before entering passages 505 so that the amount of gas is distributed evenly. Then the fuel gas enters the passages 505 (each of which is formed by the channel sides 202 and channel bottom 203 in FIG. 2); hydrogen is oxidized in the membrane-electrode assembly and electrons enter ribs 504 (the ribs 207 in FIG. 2). The gas is then discharged from the manifold on the opposite side.

The manifold position in the separator is not limited to the center as shown in FIG. 5; the manifold may be disposed at any position if passages can be formed. The passages may be straight as shown in FIG. 5 or may meander.

Table 1 shows the relation between fuel gas passage shapes and the standard deviations of voltage.

[Table 1]

TABLE 1
Relation between fuel gas passage shapes and the
standard deviations of voltage

| | | | | | | | Standard | |
|---|---|---|---|---|---|---|---|---|
| | Fuel gas | | | Oxidant gas | | | deviation | |
| | passage | | | passage | | | of | |
| | A | B | | A | B | | voltage | |
| Experiment | (mm) | (mm) | Classification | (mm) | (mm) | Classification | (mV) | Decision |
| E1 | 1 | 0.2 | x | 1 | 0.7 | ∘ | 11 | x |
| E2 | 1 | 0.5 | ∘ | 1 | | ∘ | 2 | ∘ |
| E3 | 1 | 1 | ∘ | 1 | | ∘ | 3 | ∘ |
| E4 | 1 | 1.5 | x | 1 | | ∘ | 12 | x |
| E5 | 1 | 0.5 | ∘ | 1 | 0.2 | x | 21 | x |
| E6 | 1 | 0.5 | ∘ | 1 | 1.5 | x | 12 | x |

The channel width A set for the fuel gas passage was fixed to 1 mm, and the channel depth B was set within the range of 0.2 to 1.5 mm. When an experiment satisfies equation (1) related to channel dimensions, ◯ is indicated in the classification column. For the oxidant gas passage, E1 to E4 satisfy equation (1). E5 and E6 were studied as examples to be compared.

These results indicate that, in E2 and E3, each of which satisfies equation (1) for both the fuel gas passage and the oxidant gas passage, the standard deviations of voltage are very small and the voltage is thus stable. In experiments in which equation (1) is not satisfied for either the fuel gas passage or the oxidant gas passage (x is indicated in the classification column), the standard deviation of voltage is a little high.

Table 2 shows the relation between oxidant gas passage shapes and the standard deviations of voltage. The channel width A set for the oxidant gas passage was fixed to 1 mm.

[Table 2]

TABLE 2
Relation between oxidant gas passage shapes and
the standard deviations of voltage.

| | | | | | | | Standard | |
|---|---|---|---|---|---|---|---|---|
| | Fuel gas | | | Oxidant gas | | | deviation | |
| | passage | | | passage | | | of | |
| | A | B | | A | B | | voltage | |
| Experiment | (mm) | (mm) | Classification | (mm) | (mm) | Classification | (mV) | Decision |
| E1 | 1 | 0.5 | ∘ | 1 | 0.2 | x | 21 | x |
| E2 | 1 | | ∘ | 1 | 0.5 | ∘ | 3 | ∘ |
| E3 | 1 | | ∘ | 1 | 0.7 | ∘ | 2 | ∘ |
| E4 | 1 | | ∘ | 1 | 1 | ∘ | 2 | ∘ |
| E5 | 1 | | ∘ | 1 | 1.5 | x | 9 | x |
| E6 | 1 | 0.2 | x | 1 | 0.7 | ∘ | 11 | x |
| E7 | 1 | 1.5 | x | 1 | 0.7 | ∘ | 12 | x |

The channel depth B was set within the range of 0.2 to 1.5 mm. When an experiment satisfies equation (1), ◯ is indicated in the classification column, satisfying the condition in the present invention. For the fuel gas passage, E1 to E5 satisfy the condition in the present invention. E6 and E7 were studied as examples to be compared.

These results indicate that, in E2 to E4, each of which satisfies the condition in the present invention for both the fuel gas passage and the oxidant gas passage, the standard deviations of voltage are very small and the voltage is thus stable. In experiments in which the condition is not satisfied for either the anode passage or the cathode passage (x is indicated in the classification column), the standard deviation of voltage is a little high.

Next, an experiment in which the value of A was reduced from 1 to 0.5 mm and another experiment in which the value of A was increased to 2 mm were conducted for comparison purposes. The standard deviations fell within a range of +2 mV, indicating that there is no significant difference. When A was set to less than 0.5 mm, the contact resistance between the separator and the MEA was increased, and a cell voltage drop of 20 mV or more was observed, indicating that A less than 0.5 mm is not suitable. When A was set to more than 2 mm, horizontal movement of the gas in the gas diffusion layer was impaired and a voltage drop was observed. Accordingly, it was found that A is preferably within the range of 0.5 to 2 mm.

What is claimed is:

1. A polymer electrolyte fuel cell having a separator for separating a fuel gas from an oxidant gas and a solid polymer electrolyte membrane, wherein the separator has a gas passage formed by a channel for flowing a fuel gas or an oxidant gas through thereof, and the shape of the cross section of the channel is restricted by a channel width A and a channel depth B, where B is greater than or equal to A/2 but smaller than or equal to A.

2. A polymer electrolyte fuel cell according to claim 1, wherein a contact angle of a water droplet on an inner wall of the channel is 90° or less.

3. A polymer electrolyte fuel cell according to claim 1, wherein a width C of a rib for the gas passage is greater than or equal to A/2 but smaller than or equal to 2A.

4. A polymer electrolyte fuel cell according to claim 1, wherein the channel width A of the separator is greater than or equal to 0.5 mm but smaller than or equal to 2 mm and the channel depth B is greater than or equal to 0.25 mm but smaller than or equal to 2 mm.

5. A polymer electrolyte fuel cell according to claim 3, wherein the width C of the rib for the gas passage is greater than or equal to 0.5 mm but smaller than or equal to 2 mm.

6. A separator used in a polymer electrolyte fuel cell to separate a fuel gas from an oxidant gas, wherein the separator has a gas passage formed by a channel for flowing a fuel gas or an oxidant gas through thereof, and the shape of the cross section of the channel is restricted by a channel width A and a channel depth B, where B is greater than or equal to A/2 but smaller than or equal to A.

7. A separator according to claim 6, wherein a contact angle of a water droplet on an inner wall of the channel is 90° or less.

8. A separator according to claim 6, wherein a width C of a rib for the gas passage is greater than or equal to A/2 but smaller than or equal to 2A.

9. A separator according to claim 6, wherein the channel width A is greater than or equal to 0.5 mm but smaller than or equal to 2 mm and the channel depth B is greater than or equal to 0.25 mm but smaller than or equal to 1 mm.

10. A separator according to claim 8, wherein the width C of the rib for the gas passage is greater than or equal to 0.5 mm but smaller than or equal to 2 mm.
